(19) United States
(12) Patent Application Publication
(10) Pub. No.: US 2009/0171579 A1
(43) Pub. Date: Jul. 2, 2009

(54) Apparatus with displaying, browsing and navigating functions for photo track log and method thereof

(76) Inventors: Shie-Ching Wu, Sanchong City (TW); Kuo-Hung Liao, Jhubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/232,934

(22) Filed: Sep. 26, 2008

(30) Foreign Application Priority Data
Dec. 26, 2007 (TW) 96150303

(51) Int. Cl. G01C 21/00

(52) U.S. Cl. 701/211; 701/208

(57) ABSTRACT

An apparatus with displaying, browsing and navigating functions for photo track log comprising a GPS (global positioning system) module, used to receive at least one positioning signal from satellite; an electronic map module, having a plurality of electronic maps; a storage module, used to store at least one geo-tagged photo and GPS track log; a displaying module; and a processor, connected to the GPS module, the electronic map module, the storage module, and the display module. The processor combines the electronic maps, the GPS track log, and the geo-tagged photo to form a photo track log which is displayed on the display module for navigation. Additionally a method of photo track log displaying, browsing and navigating is disclosed.

### BACKGROUND OF THE INVENTION

1. Field of the Invention

The invention generally relates to a navigating apparatus and a navigating method, and more particularly to an apparatus with displaying, browsing and navigating functions for photo track log and method thereof.

2. Description of the Related Art

As tourism industry starts booming and electronic products gains in popularity, a satellite navigating system using global positioning system (GPS) has become a widely used guide tool. The GPS retrieves the current position data of user and then guides the user to his or her destination after the user input a destination. Extra functions such as picture capturing, music playing, or maps with entertainment information such as travel spots or traffic reports have been added to the GPS. GPS tracking records various kind of information regarding positioning points while the user is moving in order for the user to view the travel tracks.

For example, TW publication No. 200710771, published on Mar. 16, 2007, discloses a GPS device with a picture taking function. This device displays the digital photos geographic information (such as location name, the longitude, and the latitude) where the pictures are taken. The pictures are tagged with the relevant geographic information which are referred to as geo-tagged photos and help the viewer to recall the time the pictures are taken.

A commercial available GPS device inherently shows the longitudes and the latitudes at different locations or simply shows geo-tagged photos. However, there is no currently available apparatus which is able to combine the geo-tagged photos with the GPS tracking, and further more possess displaying and browsing functions, all combined with navigating function by using the geo-tagged photos with the GPS tracking.

Therefore, there is a need of a novel digital camera which combines the geo-tagged photos with the GPS tracking for the user to conveniently refer to the geographic information and positioning data while viewing the digital images.

### SUMMARY OF THE INVENTION

An object of the invention is to provide an apparatus with displaying, browsing and navigating functions for photo track log and method thereof, which is able to display and allow the browsing of photo track log and furthermore navigate the user with the photo track log.

In order to achieve the above and other objectives of present invention, an apparatus with displaying, browsing and navigating functions for photo track log comprising a GPS (global positioning system) module, used to receive at least one positioning signal from satellite; an electronic map module, having a plurality of electronic maps; a storage module used to store at least one geo-tagged photo and GPS track log; a display module; and a processor connected respectively to the GPS module, the electronic map module, the storage module, and the display module; wherein the processor combines the electronic maps, the GPS track log and the geo-tagged photo to form a photo track log which is displayed on the display module for navigation.

A method of displaying, browsing and navigating the photo track log includes steps of selecting a GPS track log in the storage module; providing a processor, wherein the processor searches an electronic map covering all positioning points according to the longitude and altitude data positioning points in the GPS track log; displaying the electronic map on the display module; displaying the positioning points of the GPS track and linking those positioning points to form a GPS track line; the processor proceed searching longitude and altitude data matching one or more geo-tagged photos; if the longitude and altitude data of the digital photo match the longitude and altitude data at any point of the GPS track line, then photo track marks are put at that point to form a photo track log; selecting one or more photo track marks as destinations for navigation; retrieving longitude and altitude data correlating to where the user locates by using GPS module; and guiding the user to reach where he or she picks via audio or graphic way according to the obtained longitude and altitude data.

The invention provides the advantages as follows. The geo-tagged photos, the GPS log and the electronic maps are combined together to form a photo track log which can be shown and browsed. The user can view the trail track and the photos captured during the travel from the photo track log. Furthermore, the user can be guided according to the photo track log and the GPS.

To provide a further understanding of the invention, the following detailed description illustrates by embodiments and examples of the present invention, this detailed description is provided only for illustrative purpose only and is not meant to limit the scope of the invention.

### BRIEF DESCRIPTION OF THE DRAWINGS

FIG. 1 is a schematic view for a photo track log according to one embodiment of the present invention.

FIG. 2 is a block diagram of an apparatus with photo track log displaying, browsing and navigating functions according to one embodiment of the present invention.

FIG. 3 is a flow chart of a method of photo track log displaying, browsing and navigating according to one embodiment of the present invention.

FIG. 4 is a schematic view of an information window of a photo track mark according to one embodiment of the present invention.

### DETAILED DESCRIPTION OF THE EMBODIMENTS

Wherever possible in the following description, like reference numerals will refer to like elements and parts unless otherwise specified.

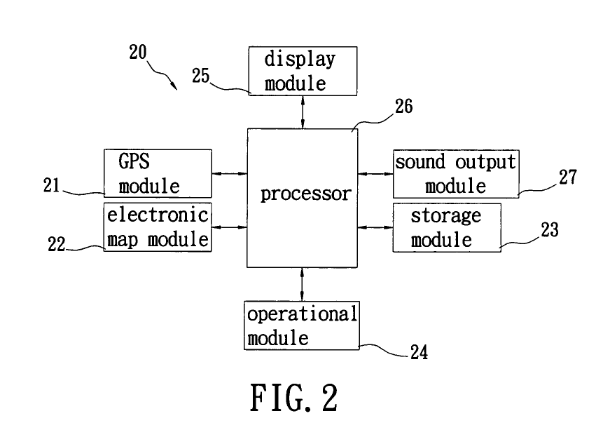

FIG. 2 is a block diagram of an apparatus with photo track log displaying, browsing and navigating functions according to one embodiment of the present invention. Apparatus 20 with photo log displaying, browsing and navigating functions comprises a GPS (global positioning system) module 21, an electronic map module 22, a storage module 23, an operational module 24, a display module 25, a processor 26, and a sound output module 27. Processor 26 is connected respectively to modules 21, 22, 23, 24, 25, and 27 so as to receive data from or transmit data to those modules.

GPS module 21 gets positioning signals periodically from a satellite so as to acknowledge the current location for its user from time to time. The relevant longitude and altitude data will be transmitted to processor 26 for navigation purpose. The positioning signals are periodically downloaded into a GPS track log which is then stored in storage module 23. The user can browse the GPS track log to view the travel track.

Electronic map module 22 stores a plurality of electronic maps which can be displayed on display module 25. Each map has geographical information corresponding to its longitude and altitude. The geographical information includes street names, landmark names, and shop's names. The user may choose the electronic map via operational module 24, in order to know the current relevant geographic information regarding the current location.

Storage module 23 is used to store the data. Processor 26 controls the data access of storage module 23. Storage module 23 can be a memory card or a miniature hard disk. Storage module 23 can be connected to an external electronic device such as a personal computer, a cell phone, or a personal digital assistant. Digital photos with geographic information (geo-tagged photos) and the GPS track log are stored in storage module 23.

Operational module 24 offers optional options for the user and processor 26 would processing according to the option the user picks. Operational module 24 can be, for example, a touch screen panel, keyboard or button.

Display module 25 can display, in addition to the electronic maps, the digital geo-tagged photos and the GPS track log in storage module 23, and any information or instructions for functional operation or navigation. Sound output module 27 is used for audio instructions during navigation.

With the use of the apparatus with photo track log displaying, browsing and navigating functions according to the present invention, the user can combine the geo-tagged photos and GPS track logs into a photo track log which the user can then review by browsing function. Alternatively, the longitude and altitude data of the photo track log can be used for navigation.

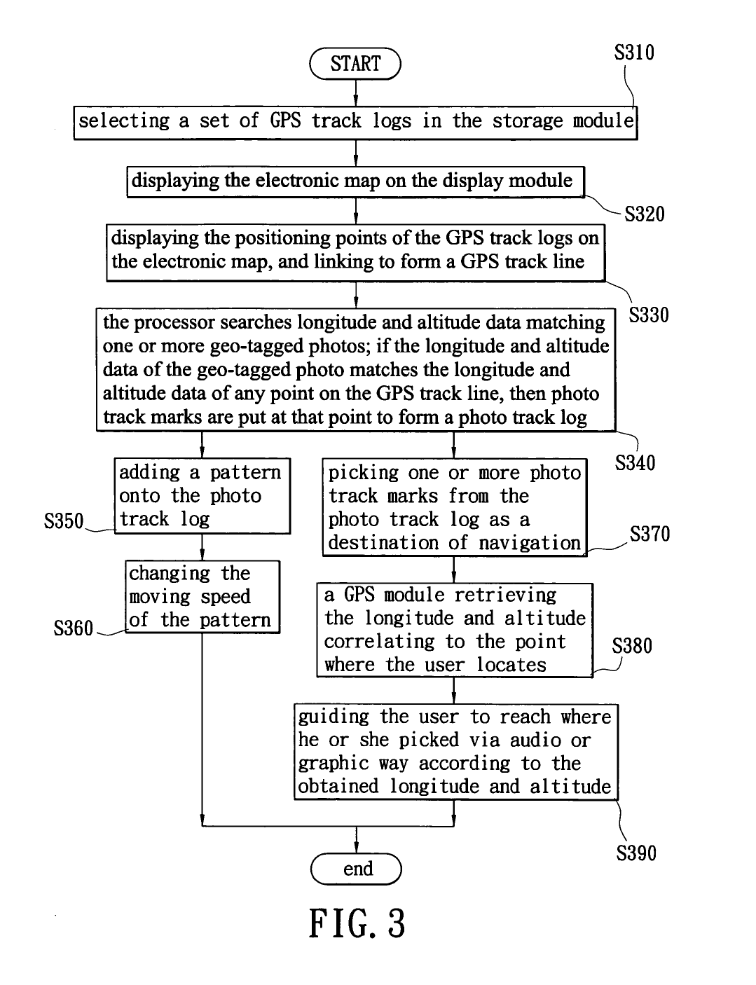

FIG. 3 is a flow chart of a method of photo track log displaying, browsing and navigating according to one embodiment of the present invention.

A set of GPS track logs in storage module 23 is selected (Step S310). A processor 26 is provided to search an electronic map covering all positioning points according to the longitude and altitude data positioning points in the GPS track logs. The electronic map is displayed on display module 25 (Step S320). The positioning points of the GPS track logs are displayed on the electronic map, and linked to form a GPS track line (Step S330).

Processor 26 searches longitude and altitude data matching one or more geo-tagged photos. If the longitude and altitude data of the geo-tagged photo matches the longitude and altitude data of any point on the GPS track line, then photo track marks are put at that point to form a photo track log (Step S340).

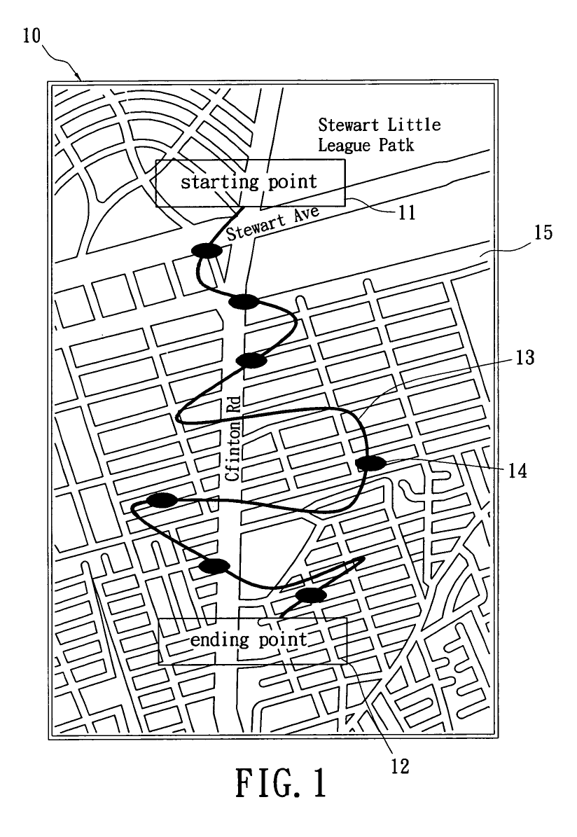

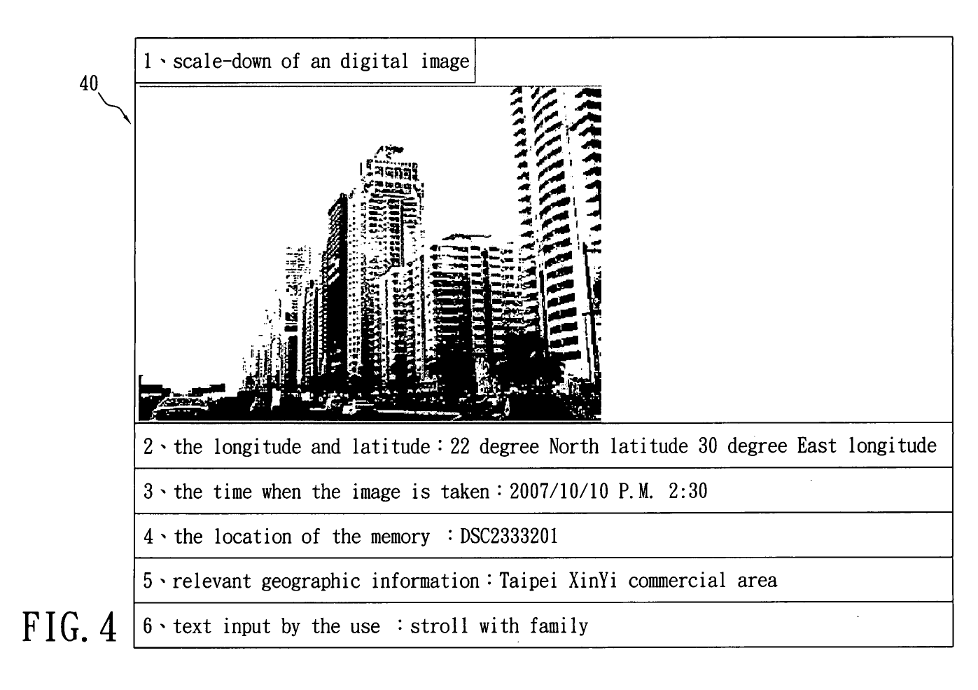

FIG. 1 is a schematic view for a photo track log according to one embodiment of the present invention. Referring to FIG. 1 and FIG. 2, a photo track log 10 includes a starting point 11 and an ending point 12, respectively representing the time to begin and the time to end the tracking. GPS track line 13 is a line formed by linking every positioning point. The GPS track line 13 has a plurality of photo track marks 14, each of which links to a corresponding geo-tagged photo. One photo track mark 14 is selected via operational module 24 to open an information window 40. As shown in FIG. 4, information window 40 displays relevant information about the geo-tagged photo on display module 25. Information window 40 contains a scaled-down picture, longitude and altitude data, picture taken time, locations of geo-tagged photos stored in storage module 23, relevant geographic information (such as names of travel spots and landmarks), and texts input by the user for the geo-tagged photo.

The user can scale up part of photo track log 10 in order to observe details of electronic map 15. Alternatively, the user can scale down photo track log 10 in order to achieve an overview of electronic map 15. He or she can shift photo track log 10 to see the surrounding neighborhood.

Furthermore, photo track log 10 can be navigated via animation. A pattern can be added onto photo track log 10 (Step S350). The pattern can be people or cars. The pattern moves from a starting point 11 to an ending point 12 along GPS track line 13. The user can change the moving speed of the pattern (Step S360). While the pattern is moving, display module 25 displays relevant geographic information at a designated point where the pattern locates. When the pattern moves onto photo track mark 14, information window 40 of photo track mark 14 is displayed.

Furthermore, the user may picks one or more photo track marks 14 from photo track log 10 as a destination of navigation (Step S370). Then, a GPS module 21 retrieves the longitude and altitude correlating to the point where the user locates (Step S380). According to the obtained longitude and altitude, the user is guided to reach where he or she picked in audio or graphic way (Step S390). Alternatively, the user selects all points of the photo track log and traces back the travel track.

It should be apparent to those skilled in the art that the above description is only illustrative of specific embodiments and examples of the present invention. The present invention should therefore cover various modifications and variations made to the herein-described structure and operations of the present invention, provided they fall within the scope of the present invention as defined in the following appended claims.

What is claimed is:

1. An apparatus with photo track log displaying, browsing, and navigating functions, comprising
a GPS (global positioning system) module, used to receive at least one positioning signal from a satellite;
an electronic map module, having a plurality of electronic maps;
a storage module, used to store at least one geo-tagged photo and GPS track log;
a display module; and
a processor, connected to the GPS module, the electronic map module, the storage module and the display module, wherein the processor combines the electronic maps, the GPS track log, and the geo-tagged photo to form a photo track log which is displayed on the display module for navigation.

2. The apparatus of claim 1, further comprising an operational module connected to the processor for the user to input an operational signal.

3. The apparatus of claim 2, further comprising a sound output module connected to the processor, wherein the sound output module is used for audio navigation.

4. The apparatus of claim 1, wherein the storage module is a memory card or a miniature hard disk.

5. A method of photo track log displaying, browsing, and navigating, comprising steps of
selecting a GPS track log in the storage module;
providing a processor, wherein the processor searches an electronic map covering all positioning points according to the longitude and altitude data positioning points in the GPS track log;
displaying the electronic map on the display module;
displaying the positioning points of the GPS track log and linking those points to form a GPS track line;
the processor searching longitude and altitude data matching one or more geo-tagged photos; if the longitude and altitude data of the digital photo match the longitude and altitude data at any point on the GPS track line, then photo track marks are put at that point to form a photo track log;
selecting one or more photo track marks as destinations for navigation;
retrieving longitude and altitude data correlating to where the user locates by using GPS module; and
guiding the user to reach where he or she picked via audio or graphic way according to the obtained longitude and altitude data.

6. The method of claim 5, further comprising generating a pattern on the photo track log; and moving the pattern on the photo track log.

7. The method of claim 5, wherein the pattern is moving on the photo track log to trace back a travel track.

8. The method of claim 5, wherein the electronic maps and the photo track log can be scaled up, scaled down, and shifted.

9. The method of claim 5, wherein one of the photo track marks has an information window including scaled-down picture, longitude and altitude data, picture taken time, locations of geo-tagged photos stored in the storage module, relevant geographic information, and texts input by the user for the geo-tagged photo.
